(19) United States
(12) Patent Application Publication
(10) Pub. No.: US 2016/0334517 A1
(43) Pub. Date: Nov. 17, 2016

(54) RADIATION DETECTOR

(71) Applicant: Shimadzu Corporation, Kyoto-shi (JP)

(72) Inventor: Masayuki Nakazawa, Kyoto-shi (JP)

(21) Appl. No.: 15/112,434

(22) PCT Filed: Jan. 28, 2014
(86) PCT No.: PCT/JP2014/051863

§ 371 Date: Jul. 19, 2016

(51) Int. Cl. G01T 1/208; G01T 1/20

(52) U.S. Cl. CPC G01T 1/208; G01T 1/2018

(57) ABSTRACT

A radiation detector is provided which is compact and operable accurately with small power consumption, which may be achieved by reducing the number of A/D conversion circuits. The time taken until analog signals are outputted from the photodetector and inputted to an A/D conversion circuit may be delayed, such that the analog signals outputted at the same time from the photodetector are inputted to the A/D conversion circuit in turn. With this construction, the analog signals outputted from the photodetector can be digitized with one A/D conversion circuit.

### RELATED APPLICATIONS

This application is the U.S. National Phase filed under 35 U.S.C. §371, of International Application No. PCT/JP2014/051863, filed on Jan. 28, 2014, the disclosure of which is incorporated by reference herein in its entirety.

### TECHNICAL FIELD

This disclosure relates to a radiation detector for detecting radiation through fluorescence, and more particularly relates to a radiation detector which can determine incidence positions of fluorescence.

### BACKGROUND ART

A specific construction of a conventional positron emission tomography apparatus (PET) for imaging a distribution of a radioactive drug will be described. A conventional PET apparatus includes a detector ring formed of radiation detectors in an annular arrangement for detecting radiation. This detector ring detects pairs of gamma rays (annihilation radiation pairs) emitted in mutually opposite directions from the radioactive drug in an inspection object.

The construction of a radiation detector 51 will be described. The radiation detector 51, as shown in FIG. 9, includes a scintillator 52 having scintillator crystals arranged in two dimensions, a photodetector 53 for detecting fluorescence generated from gamma rays absorbed by the scintillator 52, and a position calculating unit 54 for determining generating positions of the fluorescence. The photodetector 53 has a detecting plane formed of detecting elements arranged in a matrix form. And the detecting plane of photodetector 53 and one surface of scintillator 52 are optically connected (see Patent Document 1, for example).

The radiation incident on the scintillator 52 is converted into numerous photons, which travel toward the photodetector 53. At this time, the photons advance through the interior of the scintillator 52 while spreading spatially, and impinge on the detecting plane of each photodetector 53 arranged in a matrix form. That is, the numerous photons by fluorescence will be distributed to a plurality of detecting elements at the same time to be detected.

The radiation detector 51 has a construction for getting to know where in the scintillator 2 the fluorescence has generated, by using detection data of the fluorescence captured by a plurality of detecting elements. That is, the radiation detector 51 determines, by means of a plurality of detecting elements, a position of the center of gravity of luminous flux of the fluorescence on the detecting plane. This position of the center of gravity is what indicates the position where the fluorescence generated. This position data is used when mapping the radioactive drug in the inspection object.

A method by which the conventional radiation detector 51 calculates the center of gravity of fluorescence will be described. For simplicity, it is assumed that the detecting plane of photodetector 53 is formed of 2×2 detecting elements as shown in FIG. 10. Detection signals of fluorescence outputted from detecting elements a1 . . . a4 are assumed to be A1 . . . A4. A1 . . . A4 indicate intensities of the fluorescence detected by the respective detecting elements a1 . . . a4. Position X of the center of gravity in x direction of the luminous flux of fluorescence is expressed as follows with the central position set to the origin:

X={(A1+A3)(A2+A4)}/{(A1+A2+A3+A4)} (1)

With (A1+A3)=Xa and (A2+A4)=Xb, a relationship X=(XaXb)/(Xa+Xb) is established.

Similarly, position Y of the center of gravity in y direction of the luminous flux of fluorescence is expressed as follows with the position a5 set to the origin:

Y={(A1+A2)(A3+A4)}/{(A1+A2+A3+A4)} (2)

With (A1+A2)=Ya and (A3+A4)=Yb, a relationship Y=(Ya−Yb)/(Ya+Yb) is established.

The radiation detector 51 of conventional construction calculates the center of gravity of fluorescence based on such a principle, and distinguishes which of the scintillator crystals forming the scintillator 52 that generate the fluorescence. When the scintillator 52 emits the fluorescence, the photodetector 53 will send detection data Xa, Xb, Ya and Yb to the position calculating unit 54. The position calculating unit 54 calculates X and Y which are the generating position of the fluorescence in the radiation detector 51 based on equations (1) and (2) above.

### PRIOR ART DOCUMENT

[Patent Document]

[Patent document 1] Unexamined Patent Publication No. 2008-122167

### SUMMARY OF INVENTION

### Technical Problem

However, the radiation detector of conventional construction has the following problem.

That is, the radiation detector of conventional construction has a problem of complicated circuitry.

According to the conventional apparatus, when fluorescence is emitted, detection data Xa, Xb, Ya and Yb are generated for one fluorescence and are outputted at the same time to the position calculating unit 54. Therefore, a line for exclusive use is provided for each of the detection data Xa, Xb, Ya and Yb between the photodetector 53 and position calculating unit 54. And the detection data outputted from the photodetector 53 are analog data. In order for the position calculating unit 54 to carry out operations like equations (1) and (2), these detection data must be converted into digital data. Considering that detection data Xa, Xb, Ya and Yb are outputted from the photodetector 53 at the same time, digitization of each detection data also needs to be carried out at the same time. The conventional apparatus therefore requires an A/D conversion circuit for each detection data as shown in FIG. 9. Sign ENG in FIG. 9 is analog data showing the intensity of fluorescence. Since this analog data is also outputted from the photodetector 53 simultaneously with the detection data Xa, Xb, Ya and Yb, an A/D conversion circuit is needed also for this analog data.

An A/D conversion circuit is a complicated circuit. According to the conventional construction, a plurality of (five in the example of FIG. 9) such complicated A/D conversion circuits are inevitably needed. Some PET apparatus require an arrangement of no less than 100 radiation detectors, and the number of A/D conversion circuits included in the PET apparatus will become considerable. Such a situation is not desirable from the viewpoint of reduction in size and cost of the PET apparatus. Besides, the A/D conversion circuits require a large amount of electric power for operation. Therefore, a PET apparatus having many A/D conversion circuits is not desirable from the viewpoint of inhibiting power consumption.

Considering that the plurality of A/D conversion circuits must be operated simultaneously as the detection data Xa, Xb, Ya and Yb are outputted all at once from the photodetector 53, the power consumption by the radiation detector 51 will increase suddenly when the plurality of A/D conversion circuits are operated. Such a change in power consumption disrupts a stable operation of the A/D conversion circuits, whereby digital data for output will fail to show right values. Such a disarray of the digital data is caused also by a clock signal supplied to the A/D conversion circuits. The clock signal is an essential requirement for driving a plurality of A/D conversion circuits synchronously, and cannot be omitted.

In consideration of the state of the art noted above, a radiation detector is described herein which is compact and operable accurately with small power consumption, which is achieved by reducing the number of A/D conversion circuits.

### Solution to Problem

A radiation detector disclosed herein comprises a scintillator for converting radiation into fluorescence; a photodetector for outputting a plurality of analog signals showing a position of generation of the fluorescence and an analog signal showing intensity of the fluorescence; an A/D conversion circuit for converting each analog signal into a digital signal; a signal delaying device for inputting in turn the analog signals outputted at the same time from the photodetector to the A/D conversion circuit by extending time taken until the analog signals outputted from the photodetector are inputted to the A/D conversion circuit; and a position calculating device for calculating where in the scintillator the fluorescence has generated based on each of the digital signals.

The radiation detector may be compact and operate accurately with small power consumption, which is achieved by restricting the number of A/D conversion circuits. The time taken until analog signals outputted from the photodetector are inputted to the A/D conversion circuit may be delayed, whereby the analog signals outputted at the same time from the photodetector are inputted to the A/D conversion circuit in turn. With this construction, all the analog signals outputted from the photodetector can be digitized with one A/D conversion circuit. Since it becomes unnecessary to provide a plurality of A/D conversion circuits for the radiation detector, power consumption can be restricted and noise can be reduced accordingly. Moreover, the radiation detector may avoid use of a clock signal for synchronizing the A/D conversion circuit, thereby eliminating possibility of producing noise due to a clock signal.

In the above radiation detector, it is preferred to comprise a pileup determining device for determining, based on a temporal interval after the photodetector inputs a trigger signal indicating generation of fluorescence in the scintillator until input of a next trigger signal, presence or absence of occurrence of a pileup which is a phenomenon in which, during a process of attenuation of the fluorescence generated by radiation impinging on the scintillator, radiation impinges on the scintillator again thereby causing intensity of the attenuating fluorescence to increase again; and a filter device for canceling, and preventing input to the A/D conversion circuit of, signals outputted from the photodetector and involved in the pileup.

By canceling signals outputted from the photodetector and involved in a pileup to stop them from being inputted to the A/D conversion circuit, the radiation detector provided can detect radiation with increased reliability.

In the above radiation detector, it is preferred that the A/D conversion circuit performs a next digitizing operation with signal intensity during occurrence of a tailing set to a baseline, which signal intensity gradually undergoes less change with progress of attenuation of the inputted analog signal.

When one analog signal after another is inputted to the A/D conversion circuit, the signal intensity relating to a tailing formed by a preceding analog signal is set to an input baseline, for digitizing a next analog signal. This can avoid a situation where the next analog signal is estimated to excess under the influence of the tailing.

In the above radiation detector, it is preferred that, of the analog signals outputted at the same time from the photodetector having detected fluorescence, the signal delaying device does not operate for one first inputted to the A/D conversion circuit.

When the signal delaying device does not cause a signal delay for the analog signal first inputted to the A/D conversion circuit, operation is carried out with as little delay as possible, and the radiation detector provided has excellent response.

In the above radiation detector, it is preferred that the signal delaying device shifts timing of inputting each analog signal to the A/D conversion circuit by delaying each analog signal for a predetermined time.

The signal delaying device may be constructed to delay each analog signal for a predetermined time. In this way, it becomes unnecessary to set a delay time individually for each analog signal.

The disclosed radiation detector according may provide a radiation detector which is compact and operable accurately with small power consumption, which is achieved by reducing the number of A/D conversion circuits. That is, this disclosure provides a construction for extending time taken until analog signals outputted from the photodetector are inputted to the A/D conversion circuit, whereby the analog signals outputted at the same time from the photodetector are inputted to the A/D conversion circuit in turn. With this construction, all the analog signals outputted from the photodetector can be digitized with one A/D conversion circuit.

### BRIEF DESCRIPTION OF DRAWINGS

FIG. 1 is a functional block diagram illustrating an entire configuration of a radiation detector according to Embodiment 1;

FIG. 2 is a plan view illustrating a construction of a photodetector according to Embodiment 1;

FIG. 3 is a time course illustrating an analog signal according to Embodiment 1;

FIG. 4 is a time course illustrating how analog signals are emitted all at once according to Embodiment 1;

FIG. 5 is a time course illustrating how the respective analog signals are delayed for different intervals according to Embodiment 1;

FIG. 6 is a time course illustrating how the analog signals are inputted at varied times to an A/D conversion circuit according to Embodiment 1;

FIG. 7 is a time course illustrating a pileup of fluorescence according to Embodiment 1;

FIG. 8 is a time course illustrating resetting of a baseline of the A/D conversion circuit according to Embodiment 1;

FIG. 9 is a schematic view illustrating a radiation detector according to a conventional construction; and

FIG. 10 is a schematic view illustrating the radiation detector according to the conventional construction.

### DESCRIPTION OF EMBODIMENTS

### Embodiment 1

### Entire Configuration of Radiation Detector

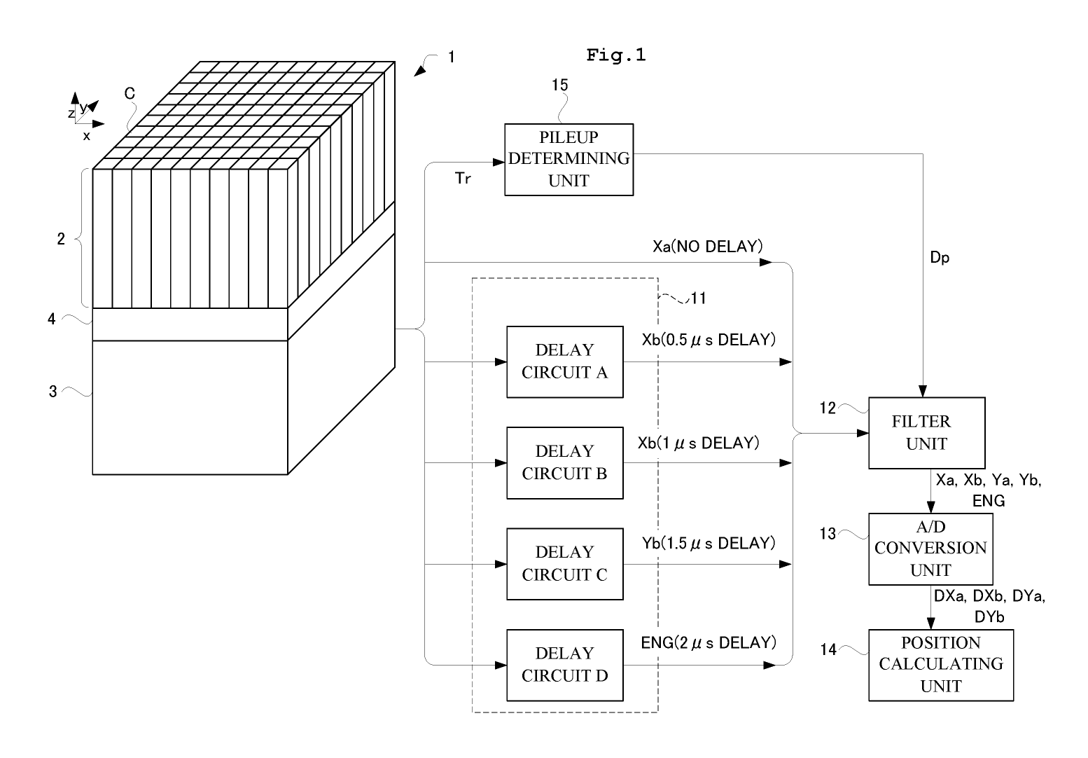

As shown in FIG. 1, a radiation detector 1 according to Embodiment 1 includes a scintillator 2 formed of scintillator crystals C arranged in a crisscross pattern, a photodetector 3 disposed under the scintillator 2 for detecting fluorescence emitted from the scintillator 2, and a light guide 4 disposed in a position interposing between the scintillator 2 and photodetector 3. Each of the scintillator crystals C may be formed of Ce-diffused Lu_{2(1-X)}Y_{2X}SiO₅ (hereinafter called LYSO). When radiation impinges on the scintillator 2, the radiation will be converted into fluorescence.

The photodetector 3 outputs analog signals required to discriminate positions of x and y of the incident fluorescence. More particularly, the photodetector 3 has a detecting plane 3b with detecting elements 3a arranged in a matrix form of 8 in a column×8 in a row, for example, and this detecting plane 3b is optically connected to the scintillator 2. When fluorescence is generated, each of the detecting elements 3a will detect the fluorescence. Based on fluorescence detection results of the detecting elements 3a, the photodetector 3 outputs analog signals Xa, Xb, Ya and Yb showing the generating position of the fluorescence, and an analog signal ENG showing intensity of the fluorescence.

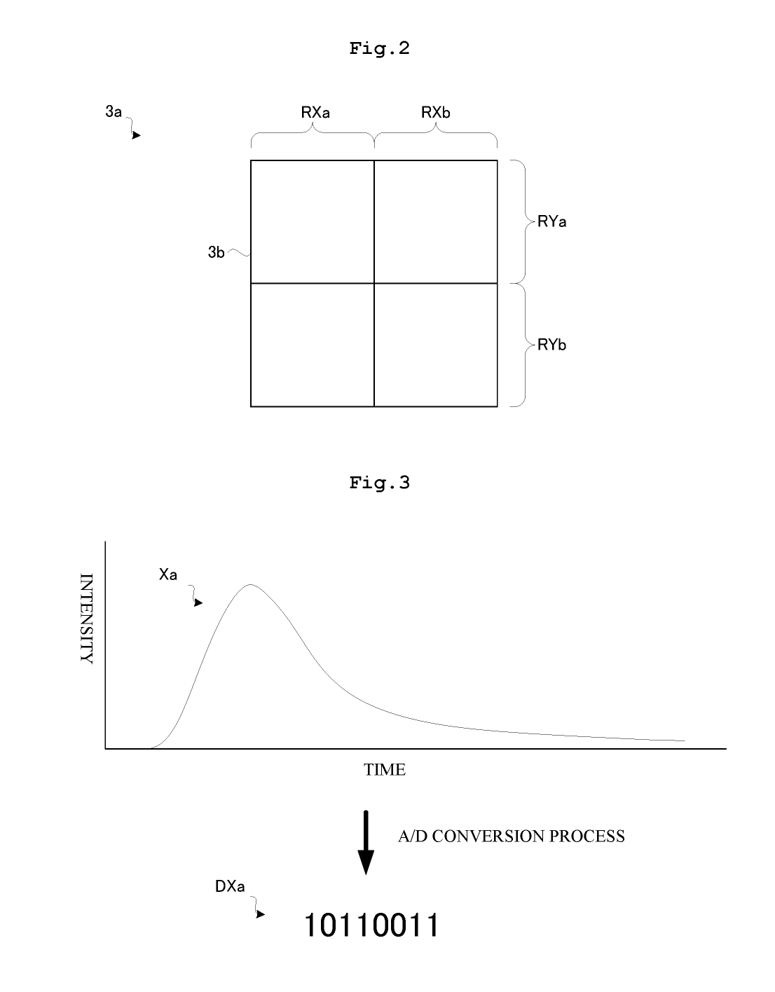

The analog signals outputted by the photodetector 3 will be described. The central point of the detecting plane 3b is regarded as the origin as shown in FIG. 2, which is used as reference for locating the generating position of fluorescence. Seen from the origin, the areas on the left-hand side are labeled RXa. Seen from the origin, the areas on the right-hand side are labeled RXb. Seen from the origin, the upper areas are labeled RYa. Seen from the origin, the lower areas are labeled RYb.

While carrying out a predetermined weighting operation, the photodetector 3 acquires total values by totaling detected intensities of the fluorescence outputted from the detecting elements 3a for the four areas of area RXa, area RXb, area RYa and area RYb. These total values will be called analog signals Xa, Xb, Ya and Yb hereinafter. The photodetector 3 also outputs analog signal ENG that shows fluorescence intensity, besides the above analog signals, concerning the generating position of the fluorescence. Since this analog signal ENG is a result of fluorescence detection on the entire detecting plane 3b, it does not have information about the generating position of fluorescence. Instead, the analog signal ENG has information concerning energy of the radiation relating to the fluorescence.

The light guide 4 is provided in order to guide the fluorescence generated in the scintillator 2 to the photodetector 3. The light guide 4 is therefore optically coupled to the scintillator 2 and photodetector 3.

<About A/D Conversion Circuit 13>

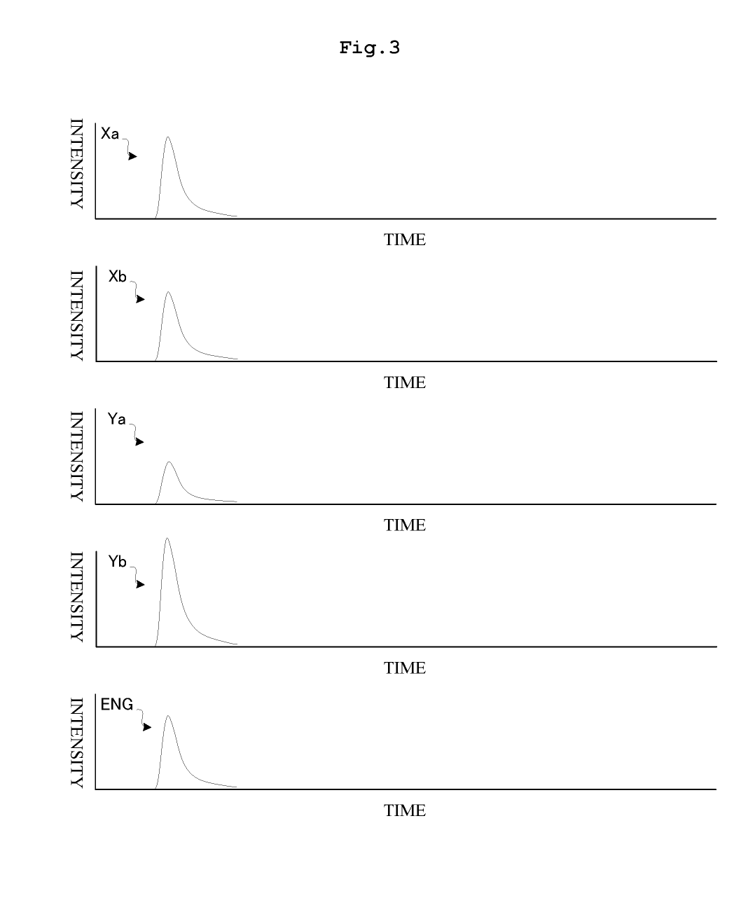

Such analog signals Xa, Xb, Ya, Yb and ENG are converted into digital signals by an A/D conversion circuit 13 as a stage prior to carrying out various calculations. FIG. 3 conceptually depicts a digitization process for the analog signal Xa. The analog signal Xa is a pulse signal, and what is obtained by integrating intensities of the analog signal Xa over time signifies the intensity of fluorescence in area RXa. The A/D conversion circuit 13 therefore integrates the analog signal Xa temporally, and outputs the result as digital signal DXa. Such a situation is the same for the other analog signals Xb, Ya, Yb and ENG. The A/D conversion circuit 13 is constructed to integrate the analog signals Xb, Ya, Yb and ENG temporally, and output the results as digital signals DXb, DYa, DYb and the DENG.

<Timing of Analog Signals Xa, Xb, Ya, Yb and ENG being Outputted>

The photodetector 3 outputs analog signals Xa, Xb, Ya, Yb and ENG upon detecting fluorescence. And the timing of outputting the analog signals is simultaneous as shown in the timing diagram of FIG. 4. This is because the analog signals are outputs relating to common fluorescence. When analog signals Xa, Xb, Ya, Yb and ENG are inputted to the A/D conversion circuit 13 without taking such a situation into consideration, A/D conversion is carried out only of a signal corresponding to a sum total of the analog signals. It is impossible to obtain digital signals DXa, DXb, DYa, DYb and DENG corresponding to the respective analog signals.

<About Signal Delaying Unit 11>

So, according to this embodiment, a signal delaying unit 11 is provided in order not to input the analog signals to the A/D conversion circuit 13 at the same time. This signal delaying unit 11 is constructed to extend time until the analog signals outputted from the photodetector 3 are inputted to the A/D conversion circuit 13, thereby to sequentially input the analog signals that are outputted at the same time from the photodetector 3 to the A/D conversion circuit 13.

This embodiment provides a construction for sequentially inputting to the A/D conversion circuit 13 in turn (separated apart by 0.5 μs), the five types of analog signals outputted from the photodetector 3. Such operation is realized by four delay circuits A-D included in the signal delaying unit 11. Among these, the delay circuit A delays inputted analog signal Xb just for 0.5 μs and inputs it to the A/D conversion circuit 13. Similarly, the delay circuit B delays inputted analog signal Ya just for 1 μs and inputs it to the A/D conversion circuit 13. The delay circuit C delays inputted analog signal Yb just for 1.5 μs and inputs it to the A/D conversion circuit 13. And the delay circuit D delays inputted analog signal ENG just for 2 μs and inputs it to the A/D conversion circuit 13. The signal delaying unit 11 corresponds to the signal delaying device in this disclosure.

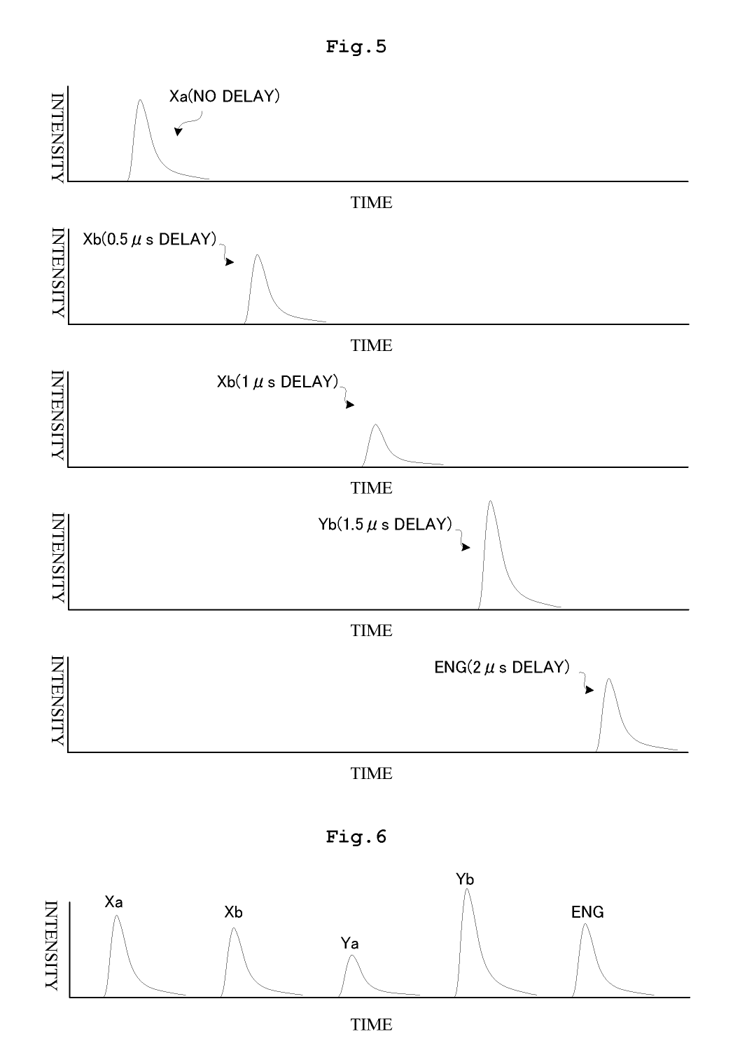

FIG. 5 depicts outputs of the signal delaying unit 11. The signal delaying unit 11 delays, relative to analog signal Xa, analog signal Xb for 0.5 μs, analog signal Ya for 1 μs, analog signal Xb for 1.5 μs, and analog signal ENG for 2 μs. Each analog signal is inputted through common wiring to a circuit relating to the A/D conversion circuit 13. At this time, the analog signals are inputted to the A/D conversion circuit 13 one after another in the order of Xa, Xb, Ya, Yb and ENG as shown in FIG. 6, with no overlapping of the analog signals. When the radiation detector 1 is used in a PET apparatus, the count rate of radiation is low enough, and radiation is detected for no more than 10 μs during a period of 100 μs. Therefore, even the construction shown in FIG. 5 which requires five times as long time as a conventional construction for digitization of radiation detection data can carry out digitizing operation with an allowance of time.

Thus, each of the analog signals is delayed by the signal delaying unit 11 just for a different unique time relative to one certain analog signal. The signal delaying unit 11 shifts the timing of inputting each analog signal to the A/D conversion circuit 13 by delaying each analog signal for a predetermined time (0.5 μs in the above example). In this way, it becomes unnecessary to set a delay time individually for each analog signal.

According to the above construction, the analog signal not delayed is Xa, but other analog signals may be provided without delay. And according to the above construction, the delay times 0.5 μs, 1 μs, 1.5 μs and 2 μs correspond to the analog signals Xb, Ya, Yb and ENG, but this invention can change this correspondence relationship as appropriate. Although each analog signal is delayed for a unit of 0.5 μs, this value can also be changed as appropriate.

The analog signal Xa is inputted to the A/D conversion circuit 13 without passing through any of the delay circuits A-D. The signal delaying unit 11 therefore has the delay circuits just one less in number than the types of analog signals outputted from the photodetector 3 that are input into the signal delaying unit 11. The number of delay circuits is so set because it is sufficient to input the plurality of analog signals to the A/D conversion circuit 13 in turn, only if the other analog signals are delayed as appropriate relative to one type of analog signal. Thus, of the analog signals outputted at the same time from the photodetector 3 having detected fluorescence, the signal delaying unit 11 does not operate for the one first inputted to the A/D conversion circuit 13. With this arrangement, since the signal delaying unit 11 does not cause a signal delay for the analog signal first inputted to the A/D conversion circuit 13, operation is carried out with as little delay as possible in operation, and response as a detector is improved.

The delay circuits A-D included in the signal delaying unit 11 are simple in construction and low in power consumption compared with circuitry for realizing the A/D conversion circuit 13. Therefore, the radiation detector may be more compact and consumes less power than the conventional construction by the number of types of analog signals.

<About Position Calculating Unit 14>

Each analog signal Xa, Xb, Ya, Yb or ENG passes through a filter unit 12, and is converted into a digital signal DXa, DXb, DYa, DYb or DENG by the A/D conversion circuit 13. Of these, the digital signals DXa, DXb, DYa and DYb that concern position determination of fluorescence are sent to a position calculating unit 14. The position calculating unit 14 calculates a fluorescence generating position (X, Y) based on the following two equations. Thus, the position calculating unit 14 calculates where in the scintillator 2 the fluorescence has generated based on each of the digital signals. The filter unit 12 corresponds to the filter device in this disclosure. The position calculating unit 14 corresponds to the position calculating device in this disclosure.

X=(DXa−DXb)/(DXa+DXb)

Y=(DYa−DYb)/(DYa+DYb)

The fluorescence generating position (X, Y) and fluorescence energy DENG are bundled together with data showing a fluorescence generating time, and outputted from the radiation detector 1 as a data set showing results of fluorescence detection.

<About Pileup Determining Unit 15>

A pileup determining unit 15 determines whether a pileup has occurred or not. This phenomenon called pileup will be described first. When radiation impinges on the scintillator 2, fluorescence will be generated and the scintillator 2 will emit light. This luminescence continues for a while, though it gradually becomes weaker, and a certain time elapses before it settles down. An analog signal outputted from the photodetector 3 takes a trailing pulse form as shown in FIG. 3, which represents how the luminescence of the scintillator 2 attenuates. The pileup determining unit 15 corresponds to the pileup determining device in this invention.

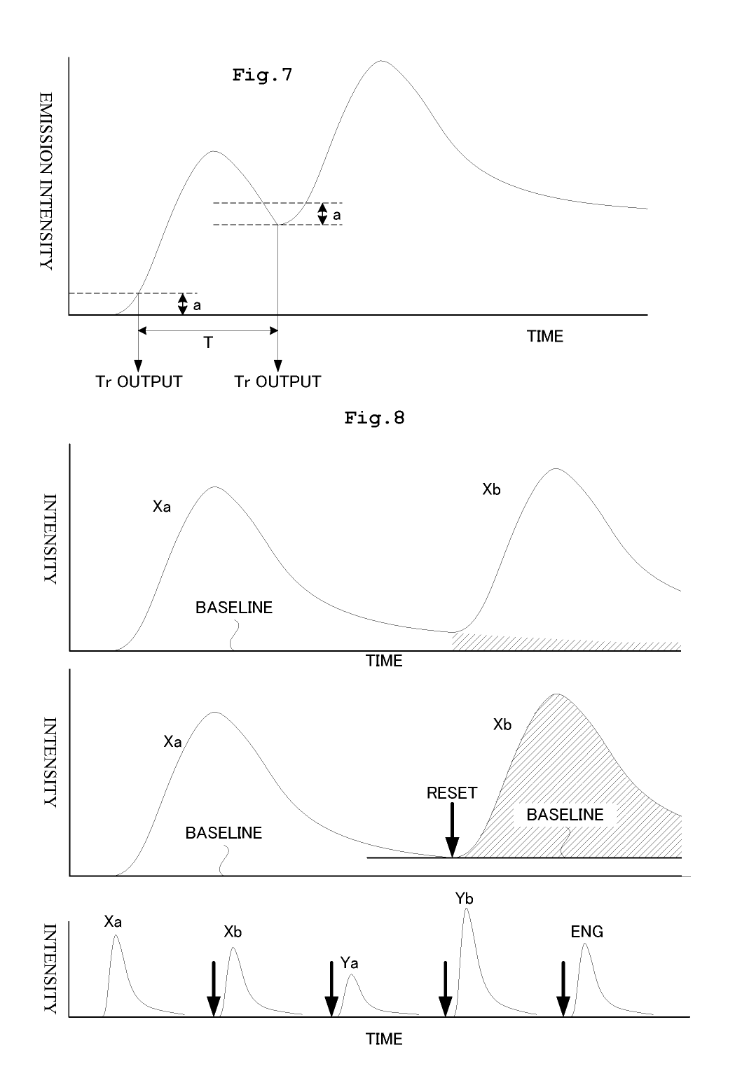

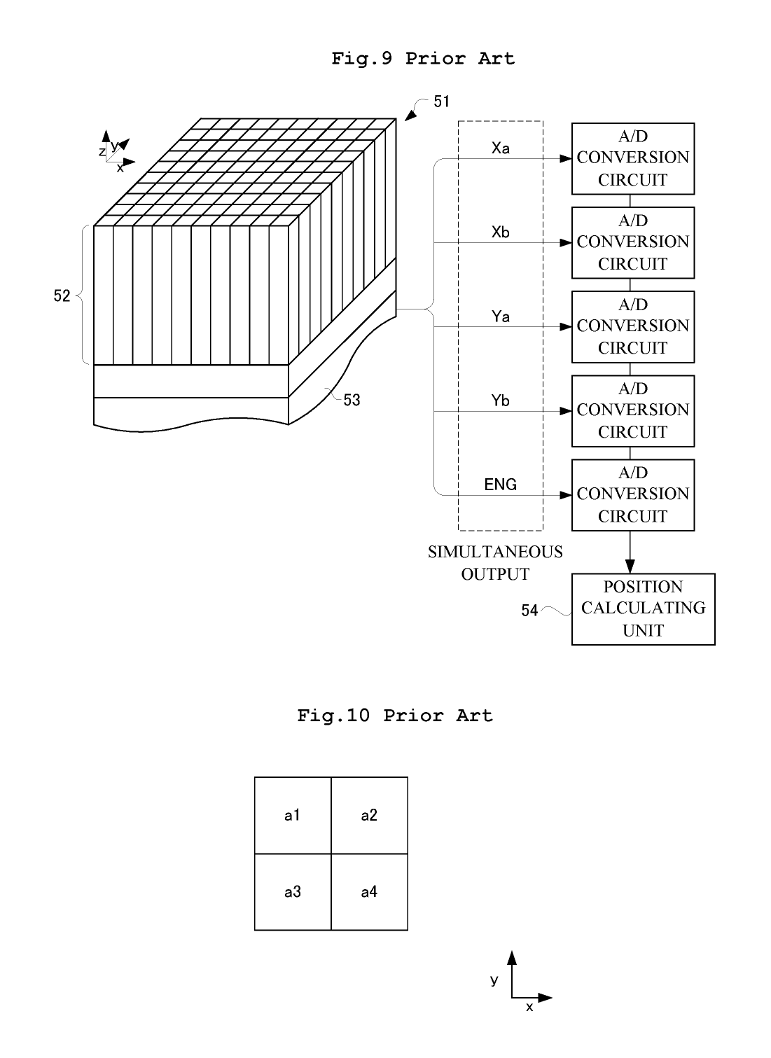

FIG. 7 depicts an inadvertent situation in which radiation impinges on the scintillator 2 having luminescence not settled enough. This situation is shown by means of variations with time of emission intensity of fluorescence that the photodetector 3 measures apart from the analog signals Xa, Xb, Ya, Yb and ENG. The phenomenon in which two emissions of fluorescence overlap each other as shown results from a plurality of radiation impinging on the scintillator 2 of radiation detector 1 within a short time, and is called a pileup.

The photodetector 3 is constructed to successively monitor the emission intensity of fluorescence, and generates a trigger signal Tr when the emission intensity has increased to a certain threshold a. This trigger signal Tr is sent to the pileup determining unit 15.

When the trigger signal Tr is sent, the pileup determining unit 15 will stand by until a next trigger signal Tr is sent. And when an interval T from a point of time when the preceding trigger signal Tr is sent to a point of time when the next trigger signal Tr is sent is equal to or less than a predetermined time, the pileup determining unit 15 determines that a pileup has occurred and outputs the determination result Dp to the filter unit 12. The filter unit 12, in response, cancels each analog signal sent thereto that are involved in the pileup, and stops them from being sent downstream to the A/D conversion circuit 13. In this way, the filter unit 12 cancels the signals outputted from the photodetector 3 and involved in the pileup, and stops them from being inputted to the A/D conversion circuit 13.

The filter unit 12 sends a signal indicating cancellation of part the signals to the A/D conversion circuit 13 and position calculating unit 14, to cause cancellation of digital signals of the analog signal Xa and so on involved in the pileup, which, of the analog signals, have arrived at the A/D conversion circuit 13 before occurrence of the pileup is determined because of earliness in the order of transmission.

Thus, based on the temporal interval after the photodetector 3 inputs a trigger signal Tr indicating that fluorescence has occurred in the scintillator 2 until it inputs a next trigger signal Tr, the pileup determining unit 15 determines presence or absence of occurrence of a pileup which is a phenomenon in which, during attenuation of the fluorescence generated by incident radiation on the scintillator 2, the attenuating intensity of the fluorescence becomes strong again.

The trigger signal Tr, although used in discriminating a pileup in this way, can be used also as a signal indicating a start of operation of the A/D conversion circuit 13 and position calculating unit 14.

<About Resetting of Baseline>

Resetting of a baseline carried out by the A/D conversion circuit 13 will now be described. Since it takes time for the fluorescence generated in the scintillator 2 to settle completely as noted above, the analog signals Xa, Xb, Ya, Yb and ENG reflecting the intensity of fluorescence also require time for completely becoming 0. The top part of FIG. 8 depicts analog signal Xa and analog signal Xb inputted with a time lag to the A/D conversion circuit 13. FIG. 8 is a time course showing the signals inputted to the A/D conversion circuit 13. It should be noted that this figure is different from FIG. 7 showing a time course of the emission intensity detected by the photodetector 3.

As shown in the top part of FIG. 8, when analog signal Xa is sent to the A/D conversion circuit 13, the input to the A/D conversion circuit 13 will not readily become 0 even after the intensity has lowered considerably. That is, analog signal Xa has formed a tailing, and its influence does not easily die down in the input side of the A/D conversion circuit 13. When this tailing is disregarded and the next analog signal Xb is sent to the A/D conversion circuit 13, as shown in the top part of FIG. 8, a signal which is a sum of a signal relating to analog signal Xb and a signal relating to the tailing of analog signal Xa will be inputted to the A/D conversion circuit 13. In such a situation, as shown in the top part of FIG. 8, when A/D conversion of the analog signal Xb is carried out, only the signal intensity due to the analog signal Xa shown in slant lines will be estimated high.

The A/D conversion circuit 13 may be constructed to reset a baseline for the purpose of solving such problem. The baseline is a signal intensity defined as 0 when the A/D conversion circuit 13 receives an analog signal, and is adjusted by the A/D conversion circuit 13 setting a bias about an input. This baseline is initially in agreement with a state where no electric current is inputted (or no voltage is applied) to the A/D conversion circuit 13. Based on this baseline, the A/D conversion circuit 13 recognizes the intensity of analog signal Xa. After measuring the magnitude of analog signal Xa, the A/D conversion circuit 13 measures the magnitude of electric current (or magnitude of voltage) inputted before the next analog signal Xb is inputted, and resets the baseline to set newly the magnitude of this amount of electricity to the baseline. When A/D conversion of the analog signal Xb is carried out after this operation, an integral value of the signal intensity due to the analog signal Xb (shown in slanted lines in the middle part of FIG. 8) is digitized. If the baseline is reset before input of the analog signal Xb in this way, the influence of the tailing of the preceding analog signal Xa will not appear at the time of digitization of the analog signal Xb.

Such a situation is the same for the subsequent analog signals Ya, Yb and ENG. Therefore, as indicated by arrows in the bottom part of FIG. 8, the A/D conversion circuit 13 may be constructed to reset the baseline on the input sides immediately before the analog signals Ya, Yb and ENG are inputted. The timing of each of the analog signals Xb, Ya, Yb and ENG being inputted to the A/D conversion circuit 13 can be known based on the analog signal Xa. That is, setting of the signal delaying unit 11 specifies timing of inputting each analog signal which is delayed for a unique delay time from receipt of the analog signal Xa.

In accordance with the above situation, the A/D conversion circuit 13, based on the setting of the signal delaying unit 11, finishes resetting of the baseline for the analog signal Xb, for example, by elapse of 0.5 μs from the point of time when the input of analog signal Xa is started. It is more desirable to carry out resetting of the baseline upon elapse of the longest possible time from the point of time when the input of analog signal Xa is started. This is because the tailing component of the preceding analog signal Xa settles down gradually with passage of time. For the other analog signals Ya, Yb and ENG also, the A/D conversion circuit 13 finishes resetting of the baseline by elapse of 1 μs, 1.5 μs and 2 μs, respectively, from the point of time when the input of analog signal Xa is started. In this way, the A/D conversion circuit 13 performs a next digitizing operation with a signal intensity during occurrence of the tailing set to the baseline, which signal intensity gradually undergoes a less change with progress of attenuation of the inputted analog signal.

The respective units 12, 14 and 15 are realized by an arithmetic unit provided for the radiation detector 1. These units may be realized by a CPU.

As described above, the radiation detector 1 is compact and operates accurately with small power consumption, which may be achieved by reducing the number of A/D conversion circuits 13. The disclosure provides a construction for extending time taken until analog signals outputted from the photodetector 3 are inputted to the A/D conversion circuit 13, whereby the analog signals outputted at the same time from the photodetector 3 are inputted to the A/D conversion circuit 13 in turn. With this construction, all the analog signals outputted from the photodetector 3 can be digitized with one A/D conversion circuit 13. Since it becomes unnecessary to provide a plurality of A/D conversion circuits 13 for the radiation detector, power consumption can be restricted and noise can be reduced accordingly. Moreover, the radiation detector 1 according to this disclosure may avoid use of a clock signal for synchronizing the A/D conversion circuit 13, thereby eliminating possibility of producing noise due to a clock signal.

Moreover, by canceling signals outputted from the photodetector 3 that are involved in a pileup to stop them from being inputted to the A/D conversion circuit 13, the radiation detector provided can detect radiation with increased reliability.

And when one analog signal after another is inputted to the A/D conversion circuit 13 as described hereinbefore, the signal intensity relating to a tailing formed by a preceding analog signal may be set to an input baseline for digitizing a next analog signal. This can avoid a situation where the next analog signal is estimated excessively when under the influence of the tailing.

This invention is not limited to the foregoing construction, but may be modified. For example:

(1) Each set value in each embodiment is given by way of example. Therefore, each set value can be changed freely.

(2) Although the scintillator crystals in each embodiment described above are formed of LYSO, it is in accordance with this invention to form the scintillator crystals of other materials such as LGSO (Lu_{2(1-X)}G_{2X}SiO₅) and GSO (Gd₂SiO₅). For example, this modification can provide a method of manufacturing a radiation detector, which can provide a less expensive radiation detector.

(3) In each embodiment described above, the photodetector may be a photomultiplier tube, a photodiode, an avalanche photodiode or a semiconductor detector may be used.

### INDUSTRIAL UTILITY

As described above, this invention may be used as part of a medical apparatus.

### REFERENCE SIGNS LIST

2 scintillator
3 photodetector
11 signal delaying unit (signal delaying device)
12 filter unit (filter device)
13 A/D conversion circuit
14 position calculating unit (position calculating device)
15 pileup determining unit (pileup determining device)

1. A radiation detector comprising:
a scintillator for converting radiation into fluorescence;
a photodetector for outputting a plurality of analog signals showing a position of generation of the fluorescence and an analog signal showing intensity of the fluorescence;
an A/D conversion circuit for converting each analog signal into a digital signal;
a signal delaying device for delaying at least some of the analog signals outputted from the photodetector and for sequentially inputting the delayed analog signals to the A/D conversion circuit; and
a position calculating device for calculating where in the scintillator the fluorescence has generated based on each of the digital signals.

2. The radiation detector according to claim 1, comprising:
a pileup determining device for determining an occurrence of a pileup based on a temporal interval after the photodetector inputs a trigger signal indicating generation of fluorescence in the scintillator until input of a next trigger signal; and
a filter device for canceling, and preventing input to the A/D conversion circuit of, signals outputted from the photodetector and involved in the pileup.

3. The radiation detector according to claim 1, wherein the A/D conversion circuit performs a next digitizing operation with signal intensity during occurrence of a tailing set to a baseline, which signal intensity gradually undergoes a less change with progress of attenuation of the inputted analog signal.

4. The radiation detector according to claim 1, wherein, of the analog signals outputted at the same time from the photodetector having detected fluorescence, the signal delaying device does not operate for one first inputted to the A/D conversion circuit.

5. The radiation detector according to claim 1, wherein the signal delaying device shifts timing of inputting each analog signal to the A/D conversion circuit by delaying each analog signal for a predetermined time.
